(19) United States
(12) Patent Application Publication
(10) Pub. No.: US 2025/0064068 A1
(43) Pub. Date: Feb. 27, 2025

(54) LOW NET CARB HARD TORTILLA SHELL AND METHOD OF PREPARATION

(71) Applicant: General Mills, Inc., Minneapolis, MN (US)

(72) Inventors: Steven Cak, Minneapolis, MN (US); John James Fenske, Shoreview, MN (US); Lindsey Golinski, Minneapolis, MN (US); Eric T. Gugger, Plymouth, MN (US); Wyatt Theis, Montrose, MN (US); Jose Daniel Estrada Andino, Dallas, TX (US)

(73) Assignee: General Mills, Inc., Minneapolis, MN (US)

(21) Appl. No.: 18/943,117

(22) Filed: Nov. 11, 2024

Related U.S. Application Data
(63) Continuation-in-part of application No. PCT/US2024/028481, filed on May 9, 2024.
(60) Provisional application No. 63/465,677, filed on May 11, 2023.

(51) Int. Cl. A21D 13/42; A21D 8/02; A21D 8/06; A23L 29/219; A23L 33/185; A23L 33/21

(52) U.S. Cl. CPC A21D 13/42; A21D 8/02; A21D 8/06; A23L 29/219; A23L 33/185; A23L 33/21

(57) ABSTRACT

A shelf stable hard tortilla shell includes a type 4 resistant starch (“RS4”) ingredient, a soluble fiber, a fine corn bran, corn masa, a plant-based protein. The shelf stable tortilla shell has a net carbohydrate content of less than 25% by weight of the tortilla shell and a moisture content of about 3% to about 11% by weight of the tortilla shell. The shelf stable tortilla shell optionally includes a fold support composition, coarse corn bran, corn grits, flavorant, coloring agent, and/or oil. A method of making a shelf stable tortilla shell includes providing a dough, forming the dough into a sheet and cooking (e.g., baking and/or frying) the sheet to form a hard taco shell, tostada or chip. The method can include gelatinizing at least some of the starch in the corn masa or in the corn bran.

### CROSS-REFERENCE TO RELATED APPLICATION

This application is a continuation-in-part application of and claims priority to International Application No. PCT/US2024/028481, filed May 9, 2024, which claims the benefit of U.S. Provisional Application No. 63/465,677, filed May 11, 2023, the entire contents of each of which are incorporated herein by reference.

### TECHNICAL FIELD

The disclosure generally pertains to food products and methods of preparing food products. More particularly, the disclosure is related to a hard tortilla shell that has a low net carbohydrate content (“low net carb”), as well as methods for preparing a low net carb tortilla shell.

### BACKGROUND

Net carbohydrate content (“net carbs”) refers to the amount of carbohydrates considered to be actually digested by a consumer and have an impact on blood sugar levels. Net carbs are calculated by subtracting the fiber content and sugar alcohol content from the total carbohydrate content. There is consumer demand for foods with low net carbohydrate content due to various health trends, including low-carbohydrate diets such as the Atkins diet and ketogenic diets. This demand is driven by the perceived benefits of these diets for weight management, improved metabolic health, and blood sugar control. Furthermore, consumers are increasingly seeking foods that contain a high level of total dietary fiber for its potential benefits to digestive health. A high-fiber diet may also be associated with improved cholesterol levels and overall cardiovascular health.

The current market offers various low-carbohydrate food products; however, these often compromise on texture, taste, or the desired nutritional profile. Specifically, existing low-carbohydrate tortilla shells frequently lack the desirable crispness and structural integrity of traditional tortilla shells, limiting their versatility and appeal to consumers accustomed to the texture of a traditional hard-shell tortilla. This deficiency creates a significant unmet need for a hard-shell tortilla that successfully balances low net carbohydrate content with a desirable texture, flavor profile, and high dietary fiber content, thus satisfying the growing consumer demand for healthier, convenient, and palatable food options.

### SUMMARY

As used herein, hard tortilla shells may encompass taco shells, tostadas and even chips. A shelf stable hard tortilla shell according to the disclosure includes a type 4 resistant starch (“RS4”) ingredient, a soluble fiber, a fine corn bran, corn masa, a plant-based protein, and optionally, a coarse corn bran, corn grits, a flavorant, a coloring agent, or a combination thereof. The RS4 ingredient is present in an amount of about 15% to about 40% by dry weight of the tortilla shell and can comprise a modified corn starch, a modified wheat starch, a modified tapioca starch, a modified potato starch, or any combination thereof. The soluble fiber is present in an amount of about 5% to about 20% by dry weight of the tortilla shell and can comprise soluble corn fiber. The fine corn bran is present in an amount of about 15% to about 52% by dry weight of the tortilla shell and comprises particles, wherein at least 80% by weight of the particles of the fine corn bran pass through a #100 mesh sieve. The plant-based protein is present in an amount of about 1% to about 10% by dry weight of the tortilla shell.

The optional coarse corn bran can be present in an amount of up to about 20% by dry weight of the tortilla shell and comprises particles, wherein at least 70% by weight of the particles of the coarse corn bran are retained on a #100 mesh sieve. In embodiments, corn grits may be present in an amount of up to about 20% by dry weight of the tortilla shell. The corn masa is present in an amount of about 5% to about 25% by dry weight of the tortilla shell. Optionally, the corn masa is pre-cooked or at least some of the starch in the corn masa is gelatinized (e.g., using warm water “no-cook” gelatinizing as described below). In some embodiments, a flavorant and/or coloring agent may be further present in an amount of up to about 10% by weight of the tortilla shell.

The shelf stable hard tortilla shell has a net carbohydrate content of less than 25% (e.g., about 10% to about 24%) by weight of the tortilla shell and a moisture content of about 3% to about 11% (e.g., of about 4% to about 10%) by weight of the tortilla shell. In certain embodiments, the shelf stable tortilla shell also includes a fold support composition in an amount of up to 5% by dry weight of the tortilla shell.

A shelf stable hard tortilla shell can optionally contain oil in an amount of up to 25% by weight.

A method of making a shelf stable tortilla shell includes providing a dough, forming the dough into a sheet and cooking (e.g., baking and/or frying) the sheet to a moisture of about 3% to about 11% by weight of the sheet to form the tortilla shell, wherein the tortilla shell has a net carbohydrate content of less than 25% by weight of the tortilla shell. The dough includes a type 4 resistant starch (“RS4”) ingredient, a soluble fiber, a fine corn bran, corn masa, and water. The water is present in an amount of about 40% to about 55% by weight of the dough and can be warm (e.g., have a temperature of about 25° C. (77° F.) to about 55° C. (131° F.)), to provide a “no-cook” gelatinizing of at least some of the starch in the corn masa.

The step of forming the dough into a sheet can include forming the sheet into a U-shape. In some embodiments, the dough sheet is formed into a U-shape during frying.

In certain embodiments, the method of making a shelf stable tortilla shell includes gelatinizing at least a portion of a starch content in the fine corn bran and/or the coarse corn bran (“cook method,” compared to “no-cook” mentioned above). This step of gelatinizing can be performed at a temperature of at least 87.8° C. (190° F.).

### DETAILED DESCRIPTION

Initially, it should be noted that the embodiments of the present disclosure described below are not intended to be exhaustive or limit the disclosure to the precise forms disclosed in the following detailed description. Rather, a purpose of the embodiments chosen and described is so that the appreciation and understanding by others skilled in the art of the principles and practices of the present disclosure can be facilitated.

In interpreting the present description, it is to be understood that the disclosure is concerned with making a hard tortilla shell and this term encompasses hard taco shells (such as U-shaped taco shells, flat bottom shells, and taco bowls), tostados, and chips (e.g., flat, curved, or bowl-shaped chips). Unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

Numeric ranges recited within the specification are inclusive of the numbers defining the range and include each integer within the defined range. Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

A shelf stable hard tortilla shell that is low in net carbs (“low net carb hard tortilla shell”) has been developed. By “low net carb” it is meant a net carbohydrate content of less than 25% (e.g., about 10% to about 24%) by weight. The tortilla shell is a hard, cooked dough product (e.g., baked or fried) that is typically sized to be hand-held. The hard tortilla shell can take various forms, such as a hard taco shell (e.g., a U-shape) filled with various ingredients such as seasoned ground beef, cheese, and lettuce. In contrast to a flexible soft tortilla that may also be used to make a taco, the hard shell of the disclosure has a set shape and a crunchy bite. As with conventional hard tortilla shells on the market, the hard tortilla shell of the present disclosure can be eaten as-is, without further processing by the consumer. A shelf stable hard tortilla shell of the present disclosure includes, but is not limited to, a type 4 resistant starch (“RS4”) ingredient, a soluble fiber, a fine corn bran, a coarse corn bran, corn masa, and plant-based protein.

The RS4 ingredient is present in an amount of about 15% to about 40% (e.g., about 18% to about 30%, or about 20% to about 25%) by dry weight of the tortilla shell and has an RS4 content of at least 75% by weight of the RS4 ingredient. Resistant starches are prebiotic dietary fibers that are non-digestible in the small intestine. RS4 is a subcategory of resistant starches and are starches chemically modified typically through esterification, cross-linking, or transglycosylation. The RS4 ingredient can comprise a modified corn starch, a modified wheat starch, a modified tapioca starch, a modified potato starch, or any combination thereof.

As used herein, the term “dry weight” refers to weight of a component exclusive of moisture and oil content. A hard tortilla shell provided herein is typically cooked (e.g., by baking and/or frying), and oil can be used during the cooking process to help promote a desired flavor, texture, and/or appearance. Thus, in some cases, a hard tortilla can contain up to 25%, about 10% to about 25%, or about 12% to about 22%, by weight of oil that is not considered part of the dry weight herein, especially if the tortilla is fried. As described throughout the disclosure, the components of the compositions may be further provided as a dough composition prior to cooking (e.g., prior to baking and/or frying).

In embodiments, the soluble fiber may be present in an amount of about 5% to about 20% (e.g., of about 7% to about 10%) by dry weight of the tortilla shell. In preferred embodiments, the soluble fiber is present in an amount of about 5% to about 12% by dry weight of the tortilla shell. The soluble fiber can comprise soluble corn fiber (e.g., soluble corn fiber in an amount of about 5% to about 12% by dry weight of the tortilla shell).

In further embodiments, the fine corn bran may be present in an amount of about 15% to about 52%, about 18% to about 40%, about 20% to about 35%, or about 20% to about 30%, by dry weight of the tortilla shell. The fine corn bran comprises particles, wherein at least 80% by weight of the particles of the fine corn bran pass through a #100 mesh sieve (i.e., a sieve having 100 openings per inch; openings of approximately 149 microns). In some embodiments, at least 25% (e.g., at least 50%) by weight of the particles of the fine corn bran pass through a #200 mesh sieve (i.e., a sieve having 200 openings per inch; openings of approximately 74 microns). In some embodiments, the fine corn bran can be ultrafine corn bran (i.e., particles less than 0.1 micron).

In some embodiments, a coarse corn bran can be further included in a tortilla shell. The coarse corn bran may be present in an amount of up to about 20% (e.g., about 5% to about 12%; preferably, about 5% to about 10%) by dry weight of the tortilla shell. The coarse corn bran comprises particles, wherein at least 70% by weight of the particles of the coarse corn bran are retained on a #100 mesh sieve. In some embodiments, at least 50% by weight of the particles of the coarse corn bran are retained on a #80 mesh sieve (i.e., a sieve having 80 openings per inch; openings of approximately 177 microns).

In further embodiments, the corn masa may be present in an amount of about 5% to about 25%, or about 7% to about 20%, by dry weight of the tortilla shell. Optionally, the corn masa is pre-cooked or at least some of the starch in the corn masa is gelatinized (e.g., using warm water “no-cook” gelatinizing as described below).

In further embodiments, the plant-based protein may be present in an amount of about 1% to about 10%, or about 1.5% to about 8%, or about 2% to about 5%, by dry weight of the tortilla shell. In aspects, many sources protein may be derived from plants. In embodiments, the plant-based protein of the disclosure may include, but is not limited to, pea, soy, canola, wheat, chickpea, potato, or a combination thereof. In aspects, the plant-based protein comprises pea, soy, canola, or a combination thereof. In examples, the plant-based protein may comprise pea protein.

In some embodiments, the plant-based protein may further possess various properties in order to provide tortilla shells having reduced cracking and breakage, while maintaining good flavor and palatability. In some aspects, the plant-based protein may be hydrolyzed. In further aspects, the plant-based protein may have a water holding capacity (g water/g sample) of about 0.4 to about 2.5, which is lower than many conventional plant-based proteins, such as, conventional pea proteins having a water holding capacity in the range of about 3 to about 4. In further aspects, the plant-based protein may have a solubility of about 15% to about 55% at a pH of about 4. The plant-based protein may further have a solubility of about 27% to about 60% at a pH of about 7. In aspects, the solubility of the plant-based proteins of the disclosure are higher than conventional plant-based proteins, having a solubility around 10% at a pH of about 4, or around 15-20% at a pH of about 7. In further aspects, the plant-based protein may have a mean particle size on a volume basis (MV) on day 7 of about 15 μm to about 55 μm. In some aspects, emulsion stability of the plant-based protein may be measured by the mean particle size. Generally, the higher the mean particle size, the lower the emulsification properties are of the particular protein.

In some embodiments, the tortilla shell may further comprise corn grits. In aspects, the corn grits—a coarsely ground form of dried corn—may contribute unique textural and functional properties to the shell. The inclusion of corn grits can enhance structural integrity and crispness by decreasing oil absorption. In further aspects, the grits' inherent starch content may interact with other components in the shell formulation to optimize the cooking and baking process, resulting in a consistently formed and uniformly textured shell. The use of corn grits can contribute to desirable machinability of the dough composition for making the tortilla shell. In embodiments, the corn grits may be present in an amount of up to about 20%, about 5% to about 20%, or about 5% to about 10%, by dry weight of the tortilla shell.

The shelf stable tortilla shell has a net carbohydrate content of less than 25% (e.g., about 10% to about 24%) by weight of the tortilla shell and a moisture content of about 3% to about 11% (e.g., of about 4% to about 10%) by weight of the tortilla shell. In some embodiments, the tortilla shell is gluten-free.

In certain embodiments, the shelf stable tortilla shell also includes a fold support composition in an amount of up to 5% by dry weight of the tortilla shell. The fold support composition supports flexibility for folding into a set shape (e.g., a U-shape taco shell, a flat bottom taco shell or a taco bowl) and includes a pregelatinized starch source in an amount of up to 4% (preferably, up to 3%) by dry weight of the tortilla shell, xanthan gum in an amount of up to 3% (preferably, up to 2%) by dry weight of the tortilla shell, and/or carboxymethylcellulose in an amount of up to 2% (preferably, up to 1.5%) by dry weight of the tortilla shell. In further embodiments, the tortilla shell composition may include additional functional ingredients, including, but not limited to, a flavorant and/or coloring agent. The additional functional ingredients may be present in an amount of up to about 10%, or up to about 5%, such as, in an amount of about 0.1% to about 5%.

In some embodiments, the tortilla shell consists of the RS4 ingredient, soluble corn fiber, fine corn bran, corn masa, pea protein, corn grits, a flavorant and/or coloring agent in an amount of up to 5% by dry weight of the tortilla shell, oil in an amount of up to 25% by weight, moisture in an amount of up to 11% by weight, and the fold support composition.

A method of making a shelf stable tortilla shell includes providing a dough, forming the dough into a sheet and cooking the sheet to a moisture of about 3% to about 11% by weight of the sheet to form the tortilla shell. The tortilla shell has a net carbohydrate content of less than 25% by weight of the tortilla shell. The dough composition may include, but is not limited to, a type 4 resistant starch (“RS4”) ingredient, a soluble fiber, a fine corn bran, corn masa, a plant-based protein, and water.

In some embodiments, the RS4 ingredient may be present in an amount of about 10% to about 35% (e.g., of about 12% to about 30%, or about 15% to about 20%) by weight of the dough and has an RS4 content of at least 75% by weight of the RS4 ingredient. The RS4 ingredient can comprise a modified corn starch, a modified wheat starch, a modified tapioca starch, a modified potato starch, or any combination thereof.

In further embodiments, the soluble fiber may be present in an amount of about 5% to about 20% (e.g., of about 5% to about 10%) by weight of the dough. In preferred embodiments, the soluble fiber is present in an amount of about 5% to about 12% by weight of the dough. The soluble fiber can comprise soluble corn fiber (e.g., soluble corn fiber in an amount of about 5% to about 10% by dry weight of the dough).

In further embodiments, the fine corn bran may be present in an amount of about 12% to about 52% (e.g., about 15% to about 45%; or about 17% to about 30%) by weight of the dough. The fine corn bran comprises particles, wherein at least 80% by weight of the particles of the fine corn bran pass through a #100 mesh sieve. In some embodiments, at least 25% by weight of the particles of the fine corn bran pass through a #200 mesh sieve. In some embodiments, the fine corn bran can be ultrafine corn bran.

In embodiments where coarse corn bran is further included, the coarse corn bran may be present in an amount of up to about 20% (e.g., about 5% to about 12%; preferably, about 5% to about 10%) by weight of the dough. The coarse corn bran comprises particles, wherein at least 70% by weight of the particles of the coarse corn bran are retained on a #100 mesh sieve. In some embodiments, at least 50% by weight of the particles of the coarse corn bran are retained on a #80 mesh sieve.

In further embodiments, the corn masa may be present in an amount of about 3% to about 25% (e.g., about 5% to about 25% or about 7% to about 20%) by weight of the dough. Optionally, the corn masa is pre-cooked or at least some of the starch in the corn masa is gelatinized (e.g., using warm water “no-cook” gelatinizing as described below).

In further embodiments, the plant-based protein may be present in an amount of about 2% to about 10% by dry weight of the dough. In aspects, many sources protein may be derived from plants. In embodiments, the plant-based protein of the disclosure may include, but is not limited to, pea, soy, canola, wheat, chickpea, potato, or a combination thereof. In aspects, the plant-based protein comprises pea, soy, canola, or a combination thereof. In examples, the plant-based protein may comprise pea protein.

In further embodiments, the water may be present in an amount of about 25% to about 55% by weight of the dough (e.g., about 25% to about 45%, or about 30% to about 40%). The water can be warm (e.g., have a temperature of about 25° C. (77° F.) to about 55° C. (131° F.) or a temperature of about 38° C. (100° F.) to about 50° C. (122° F.)), to provide a “no-cook” gelatinizing of at least some of the starch in the corn masa.

The step of forming the dough into a sheet can include forming the sheet into a particular shape. For example, the sheet can be formed to make a taco shell having a U-shape or a taco bowl. In some embodiments, the sheet is cooked to an intermediate moisture of from about 20% to about 30% by weight. Cooking can include baking the sheet and/or frying the sheet. In some embodiments, the dough sheet is formed into a particular shape during frying.

In some embodiments, the method of making a shelf stable tortilla shell includes gelatinizing at least a portion of a starch content in the fine corn bran and/or the coarse corn bran (“cook method,” compared to “no-cook” mentioned above). This step of gelatinizing can be performed at a temperature of at least 87.8° C. (190° F.).

Optionally, the dough includes a fold support composition in an amount of up to 5% by dry weight of the dough to support flexibility for folding into a set shape (e.g., a U-shape). The fold support composition includes a pregelatinized starch source in an amount of up to 4% by dry weight of the dough (preferably, up to 3%), a xanthan gum in an amount of up to 3% by dry weight of the dough (preferably, up to 2%) and/or carboxymethylcellulose in an amount of up to 2% by dry weight of the dough (preferably, up to 1.5%). The pregelatinized starch source can supplement the “no-cook” gelatinizing of at least some of the starch in the corn masa achieved by warm water in the dough (mentioned above).

In optional embodiments, the cooked/fried tortilla shells may be coated with additional flavorant. For example, a seasoning mix may be further added to the tortilla shells to coat the shells for additional flavor.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this invention, and can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

A variety of tortilla shell formulations were prepared for evaluating the structural and organoleptic properties of the low-carbohydrate tortilla shells of the present disclosure. In particular, the shells were assessed for cracking, flakiness/integrity, crispiness, tooth packing, and flavor. The dough formulations are provided in Table 1 below. As shown within Table 1, Samples 1, 2, and 3 all included different pea protein sources (pea protein 1, pea protein 2, and pea protein 3). A few exemplary parameters for each of the pea proteins used are further provided in Table 2.

TABLE 1

| | Control | Sample 1 | Sample 2 | Sample 3 | Sample 4 | Sample 5 |
|---|---|---|---|---|---|---|
| Ingredient | (wt-%) | | | | | |
| Tapioca Starch | 19.3 | 19.3 | 19.3 | 19.3 | 19.3 | 19.3 |
| Soluble Corn Fiber | 5.3 | 8 | 5.3 | 5.3 | 5.3 | 5.3 |
| Fine Corn Bran | 23.1 | 21.6 | 21.6 | 21.6 | 21.6 | 21.1 |
| Corn Masa | 9.8 | 8.8 | 8.8 | 8.8 | 8.8 | 8.8 |
| Xanthan Gum | 1.5 | 1.0 | 1.0 | 1.5 | 1.5 | 1.0 |
| Pre-gel Starch | 1.4 | 1.4 | 1.4 | 1.4 | 1.4 | 1.4 |
| Carboxy- | 1 | 0.8 | 0.8 | 1.0 | 1.0 | 0.8 |
| methylcellulose | | | | | | |
| Additional | 0.7 | 0.7 | 0.7 | 0.7 | 0.7 | 0.7 |
| Functional | | | | | | |
| Ingredient(s) | | | | | | |
| Pea Protein 1 | 0 | 2.5 | 0 | 0 | 0 | 0 |
| Pea Protein 2 | 0 | 0 | 2.5 | 0 | 0 | 0 |
| Pea Protein 3 | 0 | 0 | 0 | 2.5 | 0 | 0 |
| Potato Protein | 0 | 0 | 0 | 0 | 2.5 | 0 |
| Chickpea Protein | 0 | 0 | 0 | 0 | 0 | 2.5 |
| Water | 37.9 | 35.9 | 38.6 | 37.9 | 37.9 | 39.1 |
| Total | 100 | 100 | 100 | 100 | 100 | 100 |

TABLE 2

| | | | Emulsion | | |
|---|---|---|---|---|---|
| | | | Stability/Mean | | |
| | Water Holding | | Particle Size | | |
| | Capacity (g | | on volume basis | | |
| | water/g | | (MV) on Day 7 | Solubility | Solubility |
| | sample) | Gelation | (μm) | (pH 4) | (pH 7) |
| Pea Protein 1 | 0.88 | Unable to gel at a | 20.1 | 45.1 | 55.4 |
| | | concentration of 30% | | | |
| Pea Protein 2 | 1.6 | Unable to gel at a | 48.5 | 20.9 | 31.3 |
| | | concentration of 30% | | | |
| Pea Protein 3 | 3.67 | Gel at a concentration of 20% | 4.0 | 7.1 | 20.7 |

The various dough formulations were prepared and cooked to form a hard tortilla shell. The tortilla shells were then evaluated based on the number of good shells, shells with minor cracking, shells with cracks along the entire spine, and broken shells. The results are shown in Table 3 below. As identified in Table 3 below, some of the formulations were assessed at various time points. For example, for the control, the shells were collected and assessed from the beginning (BEG), middle (MID), and end (END) of each batch. For a number of the Samples, each batch further was assessed after being cooked at various oven temperatures (i.e., 425° F. (˜218° C.), 500° F. (260°° C.), 600° F. (˜315° C.)). Table 3 further includes samples with their fried moisture levels (%), if collected.

TABLE 3

| | Fried | Good | Minor | Crack Along | Broken |
|---|---|---|---|---|---|
| | Moisture | Shells | Crack | Whole Spine | Shells |
| Sample | (%) | (%) | (%) | (%) | (%) |
| Control | 7.9% | 3% | 65% | 24% | 7% |
| (425° F. - BEG) | | | | | |
| Control | N/A | 7% | 67% | 27% | 0% |
| (425° F. - MID) | | | | | |
| Control | N/A | 7% | 67% | 23% | 3% |
| (425° F. - END) | | | | | |
| Sample 1 | 8.1% | 90% | 10% | 0% | 0% |
| (425° F. - BEG) | | | | | |
| Sample 1 | 6.7% | 96% | 4% | 0% | 0% |
| (500° F. - MID) | | | | | |
| Sample 1 | 2.6% | 77% | 20% | 0% | 3% |
| (600° F. - END) | | | | | |
| Sample 2 | 8.4% | 50% | 30% | 17% | 3% |
| (430° F.; BEG) | | | | | |
| Sample 2 | 6.0% | 90% | 7% | 0% | 3% |
| (430° F.; MID) | | | | | |
| Sample 3 | 6.4% | 0% | 24% | 64.7% | 12% |
| (425° F. -BEG) | | | | | |
| Sample 3 (425° | 9.4% | 0% | 25% | 75% | 0% |
| F. - MID/END) | | | | | |
| Sample 4 | 9.6% | 3% | 30% | 60% | 7% |
| (425° F. - END) | | | | | |
| Sample 5 | 6.7% | 86% | 10% | 3% | 0% |
| (425° F. - END) | | | | | |

The hard tortilla shells were then assessed for properties including cracking, crisp texture, tooth packing, flavor, and flakiness/integrity. Each sample was compared to the control, with a scoring scale from 1 to 5. The results are shown below in Table 4. Sample 3 was not assessed in view of the unsatisfactory results provided above in Table 3. As multiple batches for each sample were run, the below scoring provides the average comparisons to control. The scoring parameters were as follows:
1=Far worse than control
2=Slightly worse than control
3=Same or similar to control
4=Slightly better than control
5=Far better than control

TABLE 4

| | Sample | Sample | Sample | Sample | Sample |
|---|---|---|---|---|---|
| | 1 | 2 | 3 | 4 | 5 |
| Cracking | 5 | 5 | N/A | 1 | 5 |
| Crisp Texture | 5 | 3 | N/A | 1 | 4 |
| Tooth Packing | 5 | 3 | N/A | 1 | 4 |
| Flavor | 4 | 3 | N/A | 2 | 4 |
| Flakiness/ | 5 | 2 | N/A | 3 | 2 |
| Integrity | | | | | |

The disclosure being thus described, the same may be varied in many ways. Such variations are not to be regarded as a departure from the scope of the disclosures and all such modifications are intended to be included within the scope of the following claims.

What is claimed is:

1. A shelf stable tortilla shell, comprising:
a. a type 4 resistant starch (RS4) ingredient in an amount of about 15% to about 40% by dry weight of the tortilla shell, the RS4 ingredient having an RS4 content of at least 75% by weight of the RS4 ingredient;
b. a soluble fiber in an amount of about 5% to about 20% by dry weight of the tortilla shell;
c. a fine corn bran in an amount of about 15% to about 52% by dry weight of the tortilla shell, the fine corn bran comprising particles, wherein at least 80% by weight of the particles of the fine corn bran pass through a #100 mesh sieve;
d. corn masa in an amount of about 5% to about 25% by dry weight of the tortilla shell;
e. a plant-based protein in an amount of about 1% to about 10% by dry weight of the tortilla shell;
f. corn grits in an amount of up to about 20% by dry weight of the tortilla shell;
g. a net carbohydrate content of less than 25% by weight of the tortilla shell;
h. oil in an amount of up to about 25% by weight; and
i. a moisture content of about 3% to about 11% by weight of the tortilla shell.

2. The tortilla shell of claim 1, wherein the RS4 comprises a modified corn starch, a modified wheat starch, a modified tapioca starch, a modified potato starch, or any combination thereof.

3. The tortilla shell of claim 1, wherein the soluble fiber comprises soluble corn fiber.

4. The tortilla shell of claim 1, wherein at least 25% by weight of the particles of the fine corn bran pass through a #200 mesh sieve.

5. The tortilla shell of claim 1, further comprising a coarse corn bran in an amount of up to about 20% by dry weight of the tortilla shell, the coarse corn bran comprising particles, wherein at least 70% by weight of the particles of the coarse corn bran are retained on a #100 mesh sieve.

6. The tortilla shell of claim 1, wherein the plant-based protein comprises pea, soy, canola, chickpea, potato, or a combination thereof.

7. The tortilla shell of claim 1, wherein the plant-based protein has a water holding capacity (g water/g sample) of between about 0.4 to about 2.5.

8. The tortilla shell of claim 1, wherein the plant-based protein has a solubility of about 15% to about 55% at a pH of about 4, a solubility of about 27% to about 60% at a pH of about 7, or a combination thereof.

9. The tortilla shell of claim 1, wherein the plant-based protein has a mean particle size on a volume basis (MV) on day 7 of about 15 μm to about 55 μm.

10. The tortilla shell of claim 1, comprising:
a. the RS4 ingredient in an amount of about 18% to about 30% by dry weight of the tortilla shell;
b. the soluble corn fiber in an amount of about 7% to about 10% by dry weight of the tortilla shell;
c. the fine corn bran in an amount of about 18% to about 40% by dry weight of the tortilla shell;
d. the corn masa in an amount of about 7% to about 20% by dry weight of the tortilla shell;
e. the plant-based protein in an amount of about 1.5% to about 8% by dry weight of the tortilla shell;
f. the corn grits in an amount of about 5% to about 20% by dry weight of the tortilla shell;
g. the net carbohydrate content of about 15% to about 24% by weight of the tortilla shell;
h. the oil in an amount of about 12% to about 22% by weight; and
i. the moisture content of about 4% to about 10% by weight of the tortilla shell.

11. The tortilla shell of claim 1, wherein the tortilla shell is gluten-free, and wherein the tortilla shell constitutes a hard taco shell, a tostada shell or a chip.

12. The tortilla shell of claim 1, further comprising a fold support composition in an amount of up to 5% by dry weight of the tortilla shell, the fold support composition including:
a. a pregelatinized starch source in an amount of up to 4% by dry weight of the tortilla shell;
b. xanthan gum in an amount of up to 3% by dry weight of the tortilla shell; and/or
c. carboxymethylcellulose in an amount of up to 2% by dry weight of the tortilla shell.

13. The tortilla shell of claim 1, further comprising a flavorant, coloring agent, or combination thereof.

14. The tortilla shell of claim 1, wherein the tortilla shell consists of:
a. RS4 ingredient;
b. soluble corn fiber;
c. fine corn bran;
d. corn masa;
e. pea protein;
f. corn grits;
e. oil;
f. flavorant and/or coloring agent in an amount of up to 5% by dry weight of the tortilla shell;
g. the fold support composition; and
h. moisture in an amount of up to 11%.

15. A method of making a shelf stable tortilla shell, comprising:
a. providing a dough, the dough comprising:
i. a type 4 resistant starch (RS4) ingredient in an amount of about 10% to about 35% by weight of the dough, the RS4 ingredient having an RS4 content of at least 75% by weight of the RS4 ingredient;
ii. a soluble fiber in an amount of about 5% to about 20% by weight of the dough;
iii. a fine corn bran in an amount of about 12% to about 52% by weight of the dough, the fine corn bran comprising particles, wherein at least 80% by weight of the particles of the fine corn bran pass through a #100 mesh sieve;
iv. corn masa in an amount of about 3% to about 25% by weight of the dough; and
v. a plant-based protein in an amount of about 0.5% to about 7% by weight of the dough;
vi. corn grits in an amount of up to about 10% by weight of the dough;
vii. water in an amount of about 25% to about 55% by weight of the dough;
b. forming the dough into a sheet; and
c. cooking the sheet to a moisture of about 3% to about 11% by weight of the sheet to form the tortilla shell, wherein the tortilla shell has a net carbohydrate content of less than 25% by weight of the tortilla shell.

16. The method of claim 15, wherein the sheet is cooked to an intermediate moisture of from about 20% to about 35% by weight, and wherein the cooking step comprises baking the sheet, frying the sheet, or a combination thereof.

17. The method of claim 15, wherein the water has a temperature of about 25° C. (77° F.) to about 55° C. (131° F.).

18. The method of claim 15, comprising gelatinizing at least a portion of a starch content in the fine corn bran at a temperature of at least 87.8° C. (190° F.).

19. The method of claim 15, wherein the dough further comprises a fold support composition in an amount of up to 5% by dry weight of the dough, the fold support composition including:
a. a pregelatinized starch source in an amount of up to 4% by weight of the dough;
b. xanthan gum in an amount of up to 3% by weight of the dough; and/or
c. carboxymethylcellulose in an amount of up to 2% by weight of the dough.

20. The method of claim 15, wherein the dough further comprises a flavorant, coloring agent, or combination thereof.
